(19) United States
(12) Patent Application Publication
(10) Pub. No.: US 2014/0366330 A1
(43) Pub. Date: Dec. 18, 2014

(54) Hand stabilizer

(71) Applicant: Richard Allen Hall, Riverdale, IL (US)

(72) Inventor: Richard Allen Hall, Riverdale, IL (US)

(21) Appl. No.: 13/998,339

(22) Filed: Jan. 13, 2014

Related U.S. Application Data
(60) Provisional application No. 61/795,544, filed on Oct. 19, 2012.

(51) Int. Cl. B25G 1/10; B25G 1/00

(52) U.S. Cl. CPC B25G 1/10; B25G 1/00
USPC 16/430

(57) ABSTRACT

A device is provided for stabilizing hands of a golfer or other user to facilitate holding or movement of a golf club or other implement by the hands. The device includes two gloves or other structures and a channel-containing arrangement to hold the implement. The device can be fabricated with various geometric relationships among the digits of the hands, including relationships employed in grips commonly used by golfers or other users, grips such as the Vardon or overlapping, the interlocking and the ten finger or baseball grips. The device can be fabricated with compositions which can include semi-rigid or rigid materials that can include metals or plastics. The device can be fabricated as a connected object. The device can include a stabilizer to assist in holding the implement stationary within the channel. The stabilizer can be a liner, which can include a Velcro material or adhesive material, or can be a hold-down mechanism such as a set screw.

### BRIEF SUMMARY

By way of introduction only, a device is presented for stabilizing the hands of a user to facilitate the proper holding or movement of an implement.

For a right handed user, the device comprises a right hand casing having at one of its ends an opening sufficiently large for insertion of, and enclosing, the right hand. Attached to the right hand casing at one of its ends there are a right thumb portion and right finger portions large enough to house the right thumb and right fingers;

For a right handed user, the device also comprises a left hand casing having at one of its ends an opening sufficiently large for insertion of, and enclosing, the left hand. Attached to the left hand casing at one of its ends are the left thumb portion and left finger portions large enough to house the left thumb and left fingers. The left hand casing is located generally below the right hand casing;

The device also comprises an implement casing attached to the right and left hand casings, as well as a channel within the implement casing with the channel shaped to enclose the shaft of the implement. At the end of the channel is an opening for insertion of the implement.

The device's casings and thumb and finger portions can optionally comprise a material which can be semi-rigid or completely rigid and further those casings and portions can optionally be inseparably attached to each other so as to form a single object. The device can also optionally comprise a stabilizer which facilitates holding the implement stationary relative to the channel. Optionally, the stabilizer can be a gripping liner along an inner surface of the channel, for example, an adhesive material or part of a hook and loop arrangement. Again, optionally the stabilizer can be a hold-down fastener. The hold-down fastener, for example, can be insertable into an opening in the implement casing and again, for example, can be a threaded rod extending outwardly from the implement casing.

The device's right and left thumb and finger portions can be fabricated in various geometric configurations, for example and optionally, configurations designed as any one of various golfing grips. These grips can include the Vardon or overlapping, the interlocking and the ten finger or baseball shapes.

References in this summary to right hand and left hand should be interchanged if the user is left-handed.

The following figures and detailed description of the preferred embodiments will more clearly demonstrate these and other objects and advantages of the invention.

### BRIEF DESCRIPTION OF THE SEVERAL VIEWS OF THE DRAWINGS

FIG. 1 is a schematic diagram of a human right hand and a human left hand.

FIG. 2 is a schematic diagram of a first preferred embodiment of a hand stabilizing invention.

FIG. 3 is a schematic diagram of a second preferred embodiment of a hand stabilizing invention.

FIG. 4 is a schematic diagram of a third preferred embodiment of a hand stabilizing invention.

### DETAILED DESCRIPTION OF THE INVENTION

This Application is a Non-Provisional Application of Provisional Application No. 61/795,544, filed on Oct. 19, 2012, which is hereby incorporated by reference.

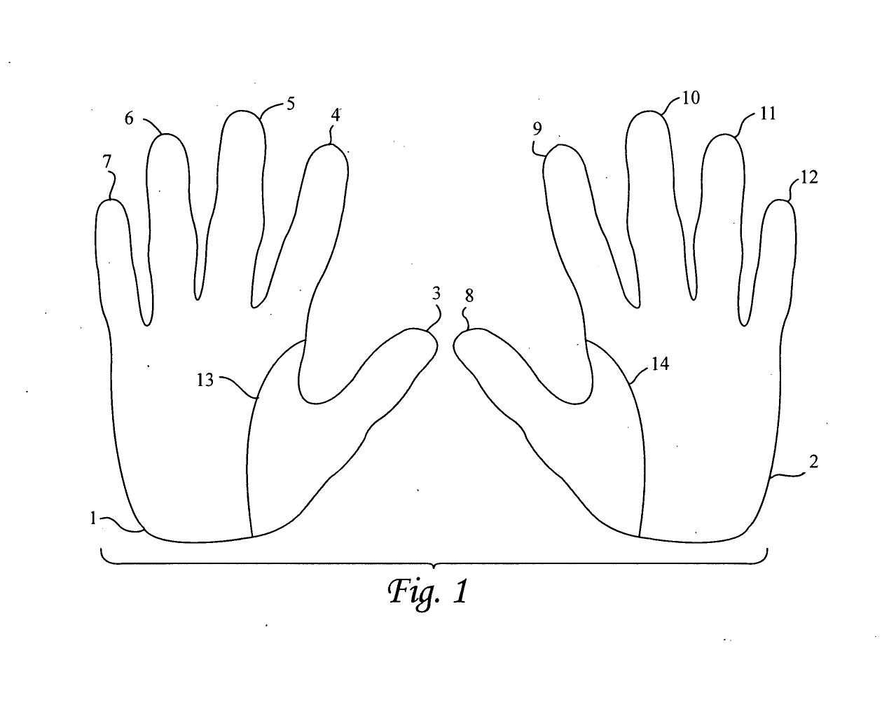

FIG. 1 depicts a human right hand 1 and left hand 2. On the right hand 1 are finger appendages referred to commonly as the right fingers, namely the right hand thumb 3, right index finger 4, right middle finger 5, right ring finger 6, and right pinkie finger 7. On the left hand 2 are finger appendages similarly referred to commonly as the left fingers, namely the left hand thumb 8, left index finger 9, left middle finger 10, left ring finger 11, and left pinkie finger 12. On each hand, respectively, are the skin creases commonly referred to as the right life line 13 and the left life line 14.

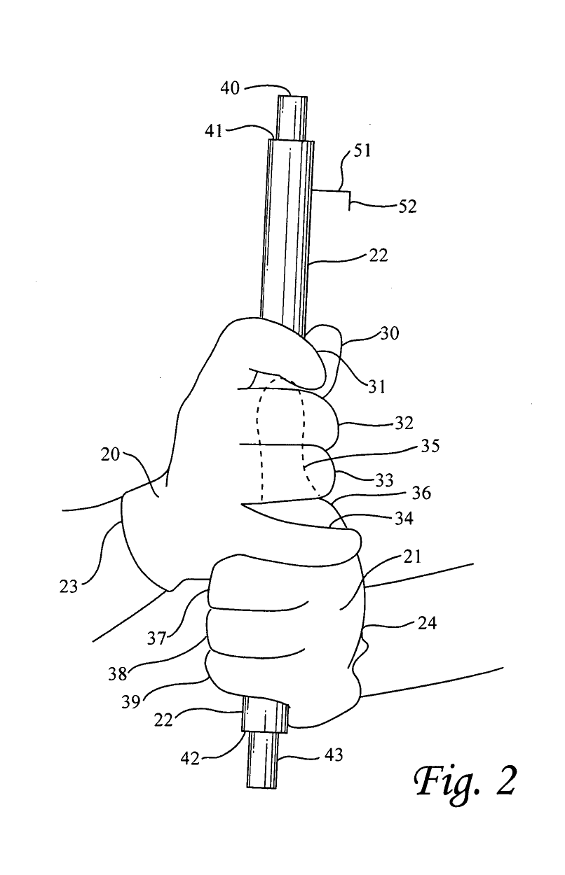

FIG. 2 depicts a first preferred embodiment of a hand stabilizing invention. The hand stabilizer is formed by three casings, a right hand casing 20, a left hand casing 21 and an implement casing 22. The right hand casing 20 has at one end a right hand opening 23 for the right hand 1 of a user. The left hand casing 21 has at one end a left hand opening 24 for the left hand 2 of a user. The user's right hand 1 can be inserted through the right hand opening 23 into the right hand casing 20 and the user's left hand 2 can be inserted through the left hand opening 24 into the left hand casing 21. The right hand casing 20 and left hand casing 21 will enclose the right hand 1 and left hand 2, respectively. At the other end of the right hand casing 20 are the right thumb portion 30 to house the right thumb 3 and also the right finger portions, namely, the right index portion 31, the right middle portion 32, the right ring portion 33, and the right pinkie portion 34, to house the right index finger 4, the right middle finger 5, the right ring finger 6, and the right pinkie finger 7, respectively. At the other end of the left hand casing 21 are the left thumb portion 35 to house the left hand thumb 8 and also the left finger portions, namely, the left index portion 36, left middle portion 37, left ring portion 38, and left pinkie portion 39, to house the left index finger 9, left middle finger 10, left ring finger 11, and left pinkie finger 12, respectively.

FIG. 2 depicts the relationship between the right and left thumb portions and the right and left finger portions, respectively, in a widely used hand stabilizing configuration or, as sometimes referred to in the art of golfing, the Vardon or overlapping grip. FIG. 2 depicts this relationship for a right handed user, a relation in which the right hand casing 20 is generally above the left hand casing 21, but with the right pinkie portion 34 situated between the left index portion 36 and the left middle portion 37. The left thumb portion 35 and right hand casing 20 are formed with the left thumb portion 35 positioned substantially beneath the right hand casing 20 in such a way that when the right hand 1 and left hand 2 are inserted into the right hand casing 20 and left hand casing 21, respectively, the left hand thumb 8 is encased substantially beneath the right life line 13.

FIG. 2 also depicts an implement casing 22 fabricated as a channel to hold the shaft 40 of an implement. The implement can be but is not restricted to a golf club. The channel has a top channel opening 41 at one end into which a shaft 40 of an implement can be inserted. That one end with the top channel opening 41 is between the right index portion 31 and the right thumb portion 30. The channel can have a bottom channel opening 42 at the other end of the channel if it is desired to pass the implement completely through the channel so that the other end 43 of the implement extends beyond the bottom channel opening 42. The top and bottom channel opening references can be interchanged if convenient for the nature of the implement.

The left index portion 36, left middle portion 37, left ring portion 38, left pinkie portion 39, right index portion 31, right middle portion 32, and right ring portion 33 are shaped to curl around the implement casing 22. The right pinkie portion 34 has the shape earlier described, and the left hand thumb 8 and left thumb portion 35 have the position also earlier described. The right thumb portion 30 is parallel to the channel and lies along the implement casing 22.

The casings 20, 21, 22 are fabricated from a rigid or semi-rigid material well known in the art such as a metal or a synthetic composition. For example the synthetic composition can be of ordinary plastic or of other materials well known to those of ordinary skill in the arts to which synthetic composition fabrication belongs. If the material is a synthetic composition, the fabrication can be a molding process as will be appreciated by those of ordinary skill in the arts of molding processing. The fabrication can be designed to convert separate two hand casings 20. 21 and implement casing 22 into a single body, with the three components rigidly connected to each other, the conversion process being any of a variety of techniques known to those of ordinary skill in the arts to which rigid connecting belongs. In the case of a synthetic composition material, the three casings 20, 21, 22 can be rigidly attached to each other by a molding process in which the three segments, the two hand casings 20, 21 and the implement casing 22, form together monolithically a single casing, the molding process being well known to those of ordinary skill in the arts above mentioned.

The implement is held stably in the channel motionless relative to the channel both rotatably and axially. This stability can be temporary because the implement can be rotated or axially moved for adjustment to a desired angle to, or distance from, the implement's point of usage and then restabilized. One example of a structure which holds the implement stable is a gripping liner which lines the inner surface of the channel, e.g., a liner made of a material which grips the implement with or without corresponding material on the implement. Velcro and an adhesive material are two possible arrangements which can provide this gripping function, as will be appreciated by those of ordinary skill in the art. above mentioned.

In another example, and without or with the gripping liner, the implement can be held, or more tightly held, as the case may be, with firm gripping strength by a hold-down fastener well-known in the art. An example of such a fastener is depicted in FIG. 2. In this example, a hold-down mechanism 51 is inserted into an opening passing through the shell of the implement casing 22 at any convenient position. As will be appreciated by those of ordinary skill in the art, this hold-down mechanism can be a threaded rod, e.g., a screw, which can have a crankshaft 52 or a thumb or slotted screw top at its end exterior to the implement casing 22. Turning the threaded rod will bring the threaded rod into contact with the implement and will thereby exert pressure on the implement so as to hold the implement motionless against the inner surface of the channel, or more tightly motionless if a liner is also used. In the case of a threaded rod, the adjustment of angle can be made by reversing the turning of the rod so as to release contact, by adjusting the angle, and finally by turning the rod again to fasten the implement. In the case of a gripping liner which can be loosened by force, force can be used to provide adjustment. The hold-down fastener can be any of a variety of fasteners well known to those of ordinary skill in the arts to which fastening belongs. This secure holding will enable the hands and their fingers and thumbs to remain immovable relative to the implement.

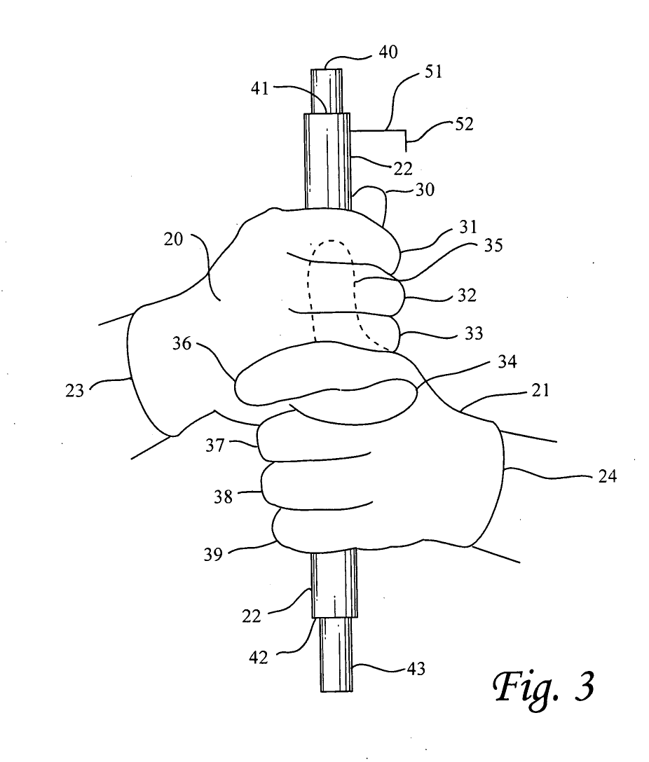

FIG. 3 depicts a second preferred embodiment of the hand stabilizing invention. The hand stabilizer is formed by three casings, a right hand casing 20, a left hand casing 21 and an implement casing 22. The right hand casing 20 has at one end a right hand opening 23 for the right hand 1 of a user. The left hand casing 21 has at one end a left hand opening 24 for the left hand 2 of a user. The user's right hand 1 can be inserted through the right hand opening 23 into the right hand casing 20 and the user's left hand 2 can be inserted through the left hand opening 24 into the left hand casing 21. The right hand casing 20 and left hand casing 21 will enclose the right hand 1 and left hand 2, respectively. At the other end of the right hand casing 20 are the right thumb portion 30 to house the right hand thumb 3 and also the right finger portions, namely, the right index portion 31, the right middle portion 32, the right ring portion 33, and the right pinkie portion 34, to house the right index finger 4, the right middle finger 5, the right ring finger 6, and the right pinkie finger 7, respectively. At the other end of the left hand casing 21 are the left thumb portion 35 to house the left hand thumb 8 and also the left finger portions, namely, the left index portion 36, left middle portion 37, left ring portion 38, and left pinkie portion 39, to house the left index finger 9, left middle finger 10, left ring finger 11, and left pinkie finger 12, respectively.

FIG. 3 depicts the relationship between the right and left thumb portions and the right and left finger portions, respectively, in another widely used grip, sometimes referred to in the art of golfing as the interlocking grip. FIG. 3 depicts this relationship for a right handed user. a relation in which the right hand casing 20 is generally above the left hand casing 21, but with the left index portion 36 overlapping, i.e., twining around or hooking around, the right pinkie portion 34. The left thumb portion 35 and right hand casing 20 are formed with the left thumb portion 35 positioned substantially beneath the right hand casing 20 in such a way that when the right hand 1 and left hand 2 are inserted into the right hand casing 20 and left hand casing 21, respectively, the left hand thumb 8 is encased substantially beneath the right life line 13.

FIG. 3 also depicts an implement casing 22 fabricated as a channel to hold the shaft 40 of an implement. The implement can be but is not restricted to a golf club. The channel has a top channel opening 42 at one end into which a shaft 40 of an implement can be inserted. The end with the top channel opening 42 is between the right index portion 31 and the right thumb portion 30. The channel can have a bottom channel opening 41 at the other end if it is desired to pass the implement completely through the channel so that the end of the implement extends beyond the bottom channel opening 41. The top and bottom channel opening references can be interchanged if convenient for the nature of the implement.

The left middle portion 37, left ring portion 38, left pinkie portion 39, right index portion 31, right middle portion 32, and right ring portion 33 are shaped to curl around the implement casing 22. The right pinkie portion 34 and left index portion 36 have the shape earlier described, and the left hand thumb 8 has the position also earlier described. The right thumb portion 30 is parallel to the channel and lies along the implement casing 22.

The casings 20, 21, 22 are fabricated from a rigid or semi-rigid material such as a metal or a synthetic composition. For example the synthetic composition can be of ordinary plastic or of other materials well known to those of ordinary skill in the arts to which synthetic composition fabrication belongs. If the material is a synthetic composition, the fabrication can be a molding process as will be appreciated by those of ordinary skill in the arts of molding processing. The fabrication can be designed to convert separate two hand casings 21, 22 and implement casing 22 into a single body, with the three components rigidly connected to each other, the conversion process being any of a variety of techniques known to those of ordinary skill in the arts to which rigid connecting belongs. In the case of a synthetic composition material, the three casings 20, 21, 22 can be rigidly attached to each other by a molding process in which the three segments, the two hand casings 21, 22 and the implement casing 22, form together monolithically a single casing, the molding process being well known to those of ordinary skill in the arts above mentioned.

The implement is held stably in the channel motionless relative to the channel both rotatably and axially. This stability can be temporary because the implement can be rotated or axially moved for adjustment to a desired angle to, or distance from, the implement's point of usage and then restabilized. One example of a structure which holds the implement stable is a gripping liner which lines the inner surface of the channel, e.g., a liner made of a material which grips the implement with or without corresponding material on the implement. Velcro and an adhesive material are two possible arrangements which can provide this gripping function.

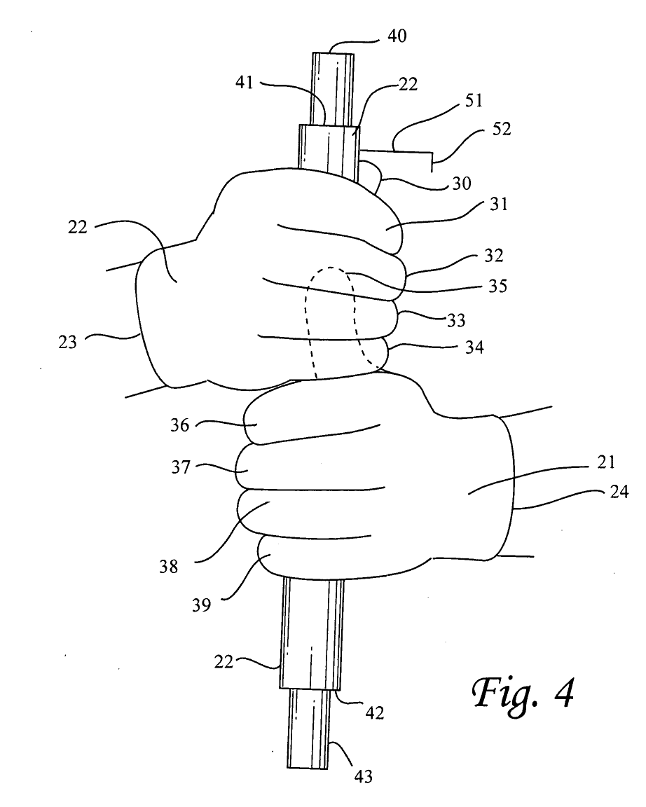

In another example, and without or with the gripping liner, the implement can be held, or more tightly held, as the case may be, with firm gripping strength by a hold-down fastener. An example of such a fastener is depicted in FIG. 4. In this example, a hold-down mechanism 51 is inserted into an opening passing through the shell of the implement casing 22 at any convenient position. This hold-down mechanism can be a threaded rod, e.g., a screw, which can have a crankshaft 52 or a thumb or slotted screw top at its end exterior to the implement casing 22. Turning the threaded rod will bring the threaded rod into contact with the implement and will thereby exert pressure on the implement so as to hold the implement motionless against the inner surface of the channel, or more tightly motionless if a liner is also used. In the case of a threaded rod, the adjustment of angle can be made by reversing the turning of the rod so as to release contact, by adjusting the angle, and finally by turning the rod again to fasten the implement. In the case of a gripping liner which can be loosened by force, force can be used to provide adjustment. The hold-down fastener can be any of a variety of fasteners well known to those of ordinary skill in the arts to which fastening belongs. This secure holding will enable the hands and their fingers and thumbs to remain immovable relative to the implement.

FIG. 4 depicts a third preferred embodiment of the hand stabilizing invention. The hand stabilizer is formed by three casings, a right hand casing 20, a left hand casing 21 and an implement casing 22. The right hand casing 20 has at one end a right hand opening 23 for the right hand 1 of a user. The left hand casing 21 has at one end a left hand opening 24 for the left hand 2 of a user. The user's right hand 1 can be inserted through the right hand opening 23 into the right hand casing 20 and the user's left hand 2 can be inserted through the left hand opening 24 into the left hand casing 21. The right hand casing 20 and left hand casing 21 will enclose the right hand 1 and left hand 2, respectively. At the other end of the right hand casing 20 are the right thumb portion 30 to house the right hand thumb 3 and also the right finger portions, namely, the right index portion 31, the right middle portion 32, the right ring portion 33, and the right pinkie portion 34, to house the right index finger 4, the right middle finger 5, the right ring finger 6, and the right pinkie finger 7, respectively. At the other end of the left hand casing 21 are the left thumb portion 35 to house the left hand thumb 8 and also the left finger portions, namely, the left index portion 36, left middle portion 37, left ring portion 38, and left pinkie portion 39, to house the left index finger 9, left middle finger 10, left ring finger 11, and left pinkie finger 12, respectively.

FIG. 4 depicts the relationship between the right and left thumb portions and the right and left finger portions, respectively, in another widely used grip, sometimes referred to in the art of golfing as the ten finger or baseball grip. FIG. 4 depicts this relationship for a right handed user, a relation in which the right hand casing 20 is generally above the left index portion 36, left middle portion 37, left ring portion 38 and left pinkie portion 39 in such a way that the right pinkie portion 34 directly contacts the left index portion 36. The left thumb portion 35 and right hand casing 20 are formed with the left thumb portion 35 positioned substantially beneath the right hand casing 20 in such a way that when the right hand 1 and left hand 2 are inserted into the right hand casing 20 and left hand casing 21, respectively, the left hand thumb 8 is encased substantially beneath the right life line 13.

FIG. 4 also depicts an implement casing 22 fabricated as a channel to hold the shaft 40 of an implement. The implement can be but is not restricted to a golf club. The channel has a top channel opening 42 at one end into which a shaft 40 of an implement can be inserted. The end with the top channel opening 42 is between the right index portion 31 and the right thumb portion 30. The channel can have a bottom channel opening 41 at the other end if it is desired to pass the implement completely through the channel so that the end of the implement extends beyond the bottom channel opening 41. The top and bottom channel opening references can be interchanged if convenient for the nature of the implement.

The left index portion 36, left middle portion 37, left ring portion 38, left pinkie portion 39, right index portion 31, right middle portion 32, right ring portion 33 and right pinkie portion 34 are shaped to curl around the implement casing 22. The left hand thumb 8 has the position also earlier described. The right thumb portion 30 is parallel to the channel and lies along the implement casing 22.

The casings 20, 21, 22 are fabricated from a rigid or semi-rigid material such as a metal or a synthetic composition. For example the synthetic composition can be of ordinary plastic or of other materials well known to those of ordinary skill in the arts to which synthetic composition fabrication belongs. If the material is a synthetic composition, the fabrication can be a molding process as will be appreciated by those of ordinary skill in the arts of molding processing. The fabrication can be designed to convert separate two hand casings 21, 22 and implement casing 22 into a single body, with the three components rigidly connected to each other, the conversion process being any of a variety of techniques known to those of ordinary skill in the arts to which rigid connecting belongs. In the case of a synthetic composition material, the three casings 20, 21, 22 can be rigidly attached to each other by a molding process in which the three segments, the two hand casings 21, 22 and the implement casing 22, form together monolithically a single casing, the molding process being well known to those of ordinary skill in the arts above mentioned.

The implement is held stably in the channel motionless relative to the channel both rotatably and axially. This stability can be temporary because the implement can be rotated or axially moved for adjustment to a desired angle to, or distance from, the implement's point of usage and then restabilized. One example of a structure which holds the implement stable is a gripping liner which lines the inner surface of the channel, e.g., a liner made of a material which grips the implement with or without corresponding material on the implement. Velcro and an adhesive material are two possible arrangements which can provide this gripping function.

In another example, and without or with the gripping liner, the implement can be held, or more tightly held, as the case may be, with firm gripping strength by a hold-down fastener. An example of such a fastener is depicted in FIG. 4. In this example, a hold-down mechanism 51 is inserted into an opening passing through the shell of the implement casing 22 at any convenient position. This hold-down mechanism can be a threaded rod, e.g., a screw, which can have a crankshaft 52 or a thumb or slotted screw top at its end exterior to the implement casing 22. Turning the threaded rod will bring the threaded rod into contact with the implement and will thereby exert pressure on the implement so as to hold the implement motionless against the inner surface of the channel, or more tightly motionless if a liner is also used. In the case of a threaded rod, the adjustment of angle can be made by reversing the turning of the rod so as to release contact, by adjusting the angle, and finally by turning the rod again to fasten the implement. In the case of a gripping liner which can be loosened by force, force can be used to provide adjustment. The hold-down fastener can be any of a variety of fasteners well known to those of ordinary skill in the arts to which fastening belongs. This secure holding will enable the hands and their fingers and thumbs to remain immovable relative to the implement.

For a left handed user, the description of the hand stabilizer is modified for all preferred embodiments by reversing the references in the text to “right” and “left.

The implement held down stably in the channel in all the preferred embodiments can be any one of a variety of items. For example, the implement can be a golf club and the angle adjustment can align the planar face of the golf club to position the face at the desired angle to, and distance from, the golf ball to be struck by the club.

The hand stabilizer described in all the preferred embodiments can be used in golfing training or even actual competition so as to bypass the need for the human hands to tightly clench the club. This tight gripping can cause an undesirable angle of, or distance from, impact between the planar surface and the golf ball. In the invention the casing firmly holds the shaft 40 of the golf club, the fingers do not provide clenching force, the full enclosure of the hands by the casing assures that the hand (including its fingers) contacts the inner surface of the casing (including its finger portions), and that the casing moves as the hands move.

The additional advantage, whether the hand stabilizer, described in all the preferred embodiments, is used in training or actual competition, is protection against failure due to ecology circumstances. The enclosure of the hands and the mechanical gripping of the shaft 40 of the implement by the casing provide this advantage. The hands are kept warm while enclosed, and their functioning and comfort level, accordingly, are made considerably independent of outdoor temperature. The grip between the shaft 40 and the channel is also immune from the problems arising from any wetness, for example, rain. The sleeve liner or hold-down fastener provides this immunity from slipping or any other difficulty arising from wetness.

Other implements for which the hand stabilizer described in all the preferred embodiments can be useful include various tools, for example snow-shovels, ordinary shovels, spades and brooms.

While the invention has been described with reference to specific embodiments, the description is illustrative of the invention and not to be construed as limiting the invention. Various modifications and applications may occur to those skilled in the art without departing from the true spirit and scope of the invention as defined in the appended claims.

1-44. (canceled)

45. A device for stabilizing hands of a user to facilitate the proper holding or movement of an implement by the hands, the device comprising:
a first hand casing having at one of its ends a first hand opening sufficiently large for insertion of a first hand of the user, the first hand casing being sufficiently large for enclosing the first hand;
a first thumb portion attached to the first hand casing at a second end thereof, the first thumb portion being sufficiently large to house a first thumb of the first hand;
a first index portion attached to the first hand casing at the second end thereof, the first index portion being sufficiently large to house a first index finger of the first hand;
a first middle portion attached to the first hand casing at the second end thereof, the first middle portion being sufficiently large to house a first middle finger of the first hand;
a first ring portion attached to the first hand casing at the second end thereof, the first ring portion being sufficiently large to house a first ring finger of the first hand;
a first pinkie portion attached to the first hand casing at the second end thereof, the first pinkie portion being sufficiently large to house a first pinkie of the first hand;
a second hand casing having at one of its ends a second hand opening sufficiently large for insertion of a second hand of the user, the second hand casing being sufficiently large for enclosing the second hand, and the second hand casing being generally located below the first hand casing;
a second thumb portion attached to the second hand casing at a second end thereof, the second thumb portion being sufficiently large to house a second thumb of the second hand, the second thumb portion being positioned substantially beneath both the first hand casing and the second thumb portion and the first hand casing being formed so that when the first hand and the second hand are inserted into the first hand casing and the second hand casing, respectively, the second thumb of the second hand is encased substantially beneath a first life line of the first hand;
a second index portion attached to the second hand casing at the second end thereof, the second index portion being sufficiently large to house a second index finger of the second hand;
a second middle portion attached to the second hand casing at the second end thereof, the second middle portion being sufficiently large to house a second middle finger of the second hand, the second middle portion being configured so that the first pinkie portion is situated between the second index portion and the second middle portion;
a second ring portion attached to the second hand casing at the second end thereof, the second ring portion being sufficiently large to house a second ring finger of the second hand;
a second pinkie portion attached to the second hand casing at the second end thereof, the second pinkie portion being sufficiently large to house a second pinkie of the second hand;
an implement casing attached to the first hand casing and to the second hand casing and configured so that the second index portion, second middle portion, second ring portion, second pinkie portion, first index portion, first middle portion and first ring portion are shaped to curl around the implement casing, and so that the first thumb portion lies along the implement casing;
a channel within the implement casing, the channel being shaped to enclose the shaft of the implement and being substantially parallel to the first thumb portion; and
an end of the channel, the channel end having an opening situated generally between the first index portion and the first thumb portion.

46. The device according to claim 45 further comprising a material from which the first hand casing, the second hand casing, the implement casing, the first and second thumb portions, the first and second index portions, the first and second middle portions, the first and second ring portions, and the first and second pinkie portions are fabricated, the material being at least partially rigid.

47. The device according to claim 46 wherein the material is completely rigid.

48. The device according to claim 47 wherein the first hand casing, the second hand casing, the implement casing, the first and second thumb portions, the first and second index portions, the first and second middle portions, the first and second ring portions, and the first and second pinkie portions are inseparably attached to each other so as to form a single object.

49. The device according to claim 48 further comprising a stabilizer which facilitates holding the implement stationary relative to the channel.

50. The device according to claim 49 wherein the stabilizer is a gripping liner along an inner surface of the channel

51. The device according to claim 49 wherein the stabilizer is a hold-down fastener.

52. A device for stabilizing hands of a user to facilitate the proper holding or movement of an implement by the hands, the device comprising:
a first hand casing having at one of its ends a first hand opening sufficiently large for insertion of a first hand of the user, the first hand casing being sufficiently large for enclosing the first hand;
a first thumb portion attached to the first hand casing at a second end thereof, the first thumb portion being sufficiently large to house a first thumb of the first hand;
a first index portion attached to the first hand casing at the second end thereof, the first index portion being sufficiently large to house a first index finger of the first hand;
a first middle portion attached to the first hand casing at the second end thereof, the first middle portion being sufficiently large to house a first middle finger of the first hand;
a first ring portion attached to the first hand casing at the second end thereof, the first ring portion being sufficiently large to house a first ring finger of the first hand;
a first pinkie portion attached to the first hand casing at the second end thereof, the first pinkie portion being sufficiently large to house a first pinkie of the first hand;
a second hand casing having at one of its ends a second hand opening sufficiently large for insertion of a second hand of the user, the second hand casing being sufficiently large for enclosing the second hand, and the second hand casing being generally located below the first hand casing;
a second thumb portion attached to the second hand casing at a second end thereof, the second thumb portion being sufficiently large to house a second thumb of the second hand, the second thumb portion being positioned substantially below the right hand casing and the second thumb portion and the first hand casing being formed so that when the first hand and the second hand are inserted into the first hand casing and the second hand casing, respectively, the second thumb of the second hand is encased substantially beneath a first life line of the first hand;
a second index portion attached to the second hand casing at the second end thereof, the second index portion being sufficiently large to house a second index finger of the second hand and the second index portion overlapping the first pinkie portion;
a second middle portion attached to the second hand casing at the second end thereof, the second middle portion being sufficiently large to house a second middle finger of the second hand;
a second ring portion attached to the second hand casing at the second end thereof, the second ring portion being sufficiently large to house a second ring finger of the second hand;
a second pinkie portion attached to the second hand casing at the second end thereof, the second pinkie portion being sufficiently large to house a second pinkie of the second hand;
an implement casing attached to the first hand casing and to the second hand casing and configured so that the second middle portion, second ring portion, second pinkie portion, first index portion, first middle portion and first ring portion are shaped to curl around the implement casing, and so that the first thumb portion lies along the implement casing;
a channel within the implement casing, the channel being shaped to enclose the shaft of the implement and being substantially parallel to the first thumb portion; and
an end of the channel, the channel end having an opening situated generally between the first index portion and the first thumb portion.

53. The device according to claim 52 further comprising a material from which the first hand casing, the second hand casing, the implement casing, the first and second thumb portions, the first and second index portions, the first and second middle portions, the first and second ring portions, and the first and second pinkie portions are fabricated, the material being at least partially rigid.

54. The device according to claim 53 wherein the material is completely rigid.

55. The device according to claim 54 wherein the first hand casing, the second hand casing, the implement casing, the first and second thumb portions, the first and second index portions, the first and second middle portions, the first and second ring portions, and the first and second pinkie portions are inseparably attached to each other so as to form a single object.

56. The device according to claim 55 further comprising a stabilizer which facilitates holding the implement stationary relative to the channel.

57. The device according to claim 56 wherein the stabilizer is a gripping liner along an inner surface of the channel

58. The device according to claim 56 wherein the stabilizer is a hold-down fastener.

59. A device for stabilizing hands of a user to facilitate the proper holding or movement of an implement by the hands, the device comprising:
a first hand casing having at one of its ends a first hand opening sufficiently large for insertion of a first hand of the user, the first hand casing being sufficiently large for enclosing the first hand;
a first thumb portion attached to the first hand casing at a second end thereof, the first thumb portion being sufficiently large to house a first thumb of the first hand;
a first index portion attached to the first hand casing at the second end thereof, the first index portion being sufficiently large to house a first index finger of the first hand;
a first middle portion attached to the first hand casing at the second end thereof, the first middle portion being sufficiently large to house a first middle finger of the first hand;
a first ring portion attached to the first hand casing at the second end thereof, the first ring portion being sufficiently large to house a first ring finger of the first hand;
a first pinkie portion attached to the first hand casing at the second end thereof, the first pinkie portion being sufficiently large to house a first pinkie of the first hand;
a second hand casing having at one of its ends a second hand opening sufficiently large for insertion of a second hand of the user, the second hand casing being sufficiently large for enclosing the second hand;
a second thumb portion attached to the second hand casing at a second end thereof, the second thumb portion being sufficiently large to house a second thumb of the second hand and the second thumb portion being positioned substantially below the first hand casing so that when the first hand and the second hand are inserted into the first hand casing and the second hand casing, respectively, the second thumb of the second hand is encased substantially beneath a first life line of the first hand;
a second index portion attached to the second hand casing at the second end thereof, the second index portion being sufficiently large to house a second index finger of the second hand and being configured so that the first pinkie portion contacts the second index portion;
a second middle portion attached to the second hand casing at the second end thereof, the second middle portion being sufficiently large to house a second middle finger of the second hand;
a second ring portion attached to the second hand casing at the second end thereof, the second ring portion being sufficiently large to house a second ring finger of the second hand;
a second pinkie portion attached to the second hand casing at the second end thereof, the second pinkie portion being sufficiently large to house a second pinkie of the second hand, and the second pinkie portion, second index portion, second middle portion, and second ring portion being positioned substantially below the first hand casing;
an implement casing attached to the first hand casing and to the second hand casing and configured so that the second index portion, the second middle portion, the second ring portion, the second pinkie portion, the first index portion, the first middle portion, the first ring portion and the first pinkie portion are shaped to curl around the implement casing, and further configured so that the first thumb portion lies along the implement casing;
a channel within the implement casing, the channel being shaped to enclose the shaft of the implement and being substantially parallel to the first thumb portion; and
an end of the channel, the channel end having an opening situated generally between the first index portion and the first thumb portion.

60. The device according to claim 59 further comprising a material from which the first hand casing, the second hand casing, the implement casing, the first and second thumb portions, the first and second index portions, the first and second middle portions, the first and second ring portions, and the first and second pinkie portions are fabricated, the material being at least partially rigid.

61. The device according to claim 60 wherein the material is completely rigid.

62. The device according to claim 61 wherein the first hand casing, the second hand casing, the implement casing, the first and second thumb portions, the first and second index portions, the first and second middle portions, the first and second ring portions, and the first and second pinkie portions are inseparably attached to each other so as to form a single object.

63. The device according to claim 62 further comprising a stabilizer which facilitates holding the implement stationary relative to the channel.

64. The device according to claim 63 wherein the stabilizer is a hold-down fastener.
